(19) United States
(12) Patent Application Publication
(10) Pub. No.: US 2008/0166673 A1
(43) Pub. Date: Jul. 10, 2008

(54) APPARATUS AND METHOD FOR MODIFYING A CONVENTIONAL FOSSIL FUEL FURNACE/BOILER TO BURN A VEGETABLE OIL

(76) Inventors: Peter Fedorow, Waterbury, CT (US); Paul Fedorow, Waterbury, CT (US)

Correspondence Address: Steven L. Schmid, 1824 Hickory Trace Dr., Fleming Island, FL, 32003, US

(21) Appl. No.: 11/857,382

(22) Filed: Sep. 18, 2007

Related U.S. Application Data
(60) Provisional application No. 60/845,841, filed on Sep. 19, 2006.

(51) Int. Cl. F23D 11/44; F23N 5/00; F16L 53/00

(52) U.S. Cl. 431/207; 431/29; 137/334

(57) ABSTRACT

Disclosed is an apparatus and method for burning vegetable oil in a conventional furnace or boiler. The invention includes heating the vegetable oil fuel to a minimum fuel temperature prior to the delivery of the vegetable oil fuel to the furnace for combustion. The minimum fuel temperature can be calculated as the vegetable oil fuel's flash point minus the ignition energy of the furnace. The invention includes a preheater for heating the vegetable oil fuel and a computing device for controlling the heating and injection of the vegetable oil fuel into the furnace.

### RELATED APPLICATION

This application relies upon U.S. Provisional Application Ser. No. 60/845,841 filed Sep. 19, 2006, the content of which is hereby incorporated in its entirety.

### TECHNICAL FIELD

The present invention relates to a heating apparatus and method. In greater detail, the present invention relates to a method and apparatus utilizing a vegetable oil for fueling a standard furnace, heater or boiler.

### BACKGROUND

Carbonaceous fuel substances, other than natural petroleum, are widely distributed throughout the world. The United States has large reserves of some of these carbonaceous fuel substances. Unfortunately, estimates of the quantities of in-place reserves that may be recoverable with current technology range no higher than about 10%. There is considerable pressure for new recovery technology and for advances that reduce the demand of non-renewable petroleum oil.

Renewable vegetable derived oil for use as residential heating oil alternative has the potential of reducing the demand for non-renewable petroleum oil. In particular soybeans made up 57% of the total world wide oilseed production. United States farmers harvested 72.16 million acres of soybeans with an average yield of 37.8 bushels/acre. The United States soybean oil and meal production industry produced 21.81 billion pounds of oil utilizing an estimated 57 million acres of soybeans. This is equivalent to 2.91 billion gallons of soybean oil ready for industrial, commercial, and food product use.

According to the United States Department of Energy's Energy Information Administration, nearly 8.1 million homes used petroleum heating oil, also known as No. 2 fuel oil. The primary area of market potential is in the Northeast and Midwest with 75% and 10% of the total household respectively. This trend is also supported by the national residential fuel oil consumption data.

The price of petroleum heating oil fluctuates drastically in the winter months due to increased usage. Many consumers stockpile petroleum heating oil during the warmer months to avoid the price spikes of winter.

Therefore, what is needed is an alternative to the use of fossil fuels in the heating homes to avoid both the rising fluctuating cost of such fuels and to reduce the country's dependency on such fuels. Furthermore, there is a need to reduce the emissions commonly found from burning such fossil fuels. Such an alternative would preferably require only minor modifications to an existing furnace.

### SUMMARY

The present invention includes both an apparatus and method for burning vegetable oil in a conventional furnace or boiler. The invention includes heating the vegetable oil fuel to a minimum fuel temperature prior to delivery of the vegetable oil fuel to the furnace for combustion. The minimum fuel temperature can be calculated as the vegetable oil fuel's flash point minus the ignition energy of the furnace. The invention includes a preheater for heating the vegetable oil fuel and a computing device for controlling the heating and injection of the vegetable oil fuel into the furnace.

In greater detail, the present apparatus for modifying a conventional fossil fuel furnace/boiler to burn a vegetable oil includes a preheater for heating the vegetable oil fuel supplied to the furnace for burning. The apparatus further includes a computing device connected to the preheater for regulating the temperature of the vegetable oil fuel supplied to the furnace. The computing device directs the preheater to heat the vegetable oil fuel to at least a minimum target temperature before the delivery of the vegetable oil fuel to the furnace for combustion.

The minimum target temperature corresponds to a type of vegetable oil fuel. The minimum target temperature is the difference between the fuel flash point of the type of vegetable fuel used minus the ignition energy of the furnace or boiler. The ignition energy is defined as the difference between the fuel flash point of No. 2 Heating Oil and minimum starting temperature for the furnace or boiler. Typically, the minimum staring temperature of a residential home furnace is 0° C. and the fuel flash point of No. 2 Heating Oil is 38° C.

In an embodiment, the minimum target temperature is the difference, plus or minus 5° C., of the fuel flash point of the type of vegetable fuel used minus the ignition energy of the furnace/boiler. An additional embodiment includes the minimum target temperature is the difference, plus or minus 10° C., of the fuel flash point of the type of vegetable fuel used minus the ignition energy of the furnace/boiler. For example, if the difference between the fuel flash point of the type of vegetable oil fuel and the ignition energy equals 250° C., then plus or minus 10° C. would mean that the minimum target temperature could be any temperature between 240° C. and 260° C. Temperatures falling within this range are commonly the minimum target temperature used for waste vegetable oil.

The present apparatus further includes the computing device directing the purging of the furnace nozzle with fuel before or at the shutdown of the furnace to prevent fuel from singing in a nozzle. Additionally included is a nozzle for atomizing the fuel in the furnace wherein the nozzle is a variable flow electronically controlled nozzle.

A further embodiment of the present invention includes an apparatus for modifying a conventional fossil fuel furnace/boiler to burn a vegetable oil comprising a preheater for heating the vegetable oil fuel supplied to the furnace for burning. The apparatus includes the computing device connected to the preheater for regulating the temperature of the vegetable oil fuel supplied to the furnace. The computing device directs the preheater to heat the vegetable oil fuel to at least a minimum target temperature, wherein the minimum target temperature is the difference, plus or minus 5° C., of the fuel flash point of the type of vegetable fuel used minus the ignition energy of the furnace/boiler.

An additional embodiment includes a method of modifying a conventional fossil fuel furnace/boiler to burn a vegetable oil. The method comprises the steps of heating the vegetable oil fuel supplied to the furnace for burning and detecting the temperature of the vegetable oil fuel supplied to the furnace for burning. The method further includes determining a minimum target temperature corresponding to a type of vegetable oil fuel, wherein the minimum target temperature is the difference, plus or minus 5° C., of the fuel flash point of the type of vegetable oil fuel used minus the ignition energy of the furnace/boiler.

Additionally, the method includes regulating the vegetable oil fuel supplied to the furnace for combustion to a temperature corresponding to the minimum target temperature. Further additions to the method include purging the nozzle with fuel before or at the shutdown of the furnace to prevent fuel from singing the nozzle and heating the oil to the target temperature prior to delivery to the furnace for combustion.

### DRAWINGS

In the drawings:

FIG. 1 is a simple block flow diagram of the vegetable oil furnace conversion of the present method and apparatus showing the computing device connected to the preheater and the preheater connected to the furnace;

FIG. 2 depicts an embodiment of the heating element for use with the present invention in the preheater;

FIG. 3 illustrates the fuel supply line wrapped around the preheater for heating the vegetable oil fuel prior to the introduction of the oil into the furnace for combustion;

FIG. 4 is a further view of the electronic fuel heater, clamps and thermo coupler; and

FIG. 5 illustrates a foil insulating cover or barrier surrounding the preheater assembly.

### DETAILED DESCRIPTION

Disclosed is both an apparatus and method for burning vegetable oil in a conventional furnace or boiler. The invention includes heating the vegetable oil fuel to a minimum fuel temperature prior to delivery of the vegetable oil fuel to the furnace for combustion. The minimum fuel temperature can be calculated as the vegetable oil fuel's flash point minus the ignition energy of the furnace. The invention includes a preheater for heating the vegetable oil fuel and a computing device for controlling the heating and injection of the vegetable oil fuel into the furnace.

In greater detail, the present apparatus for modifying a conventional fossil fuel furnace/boiler to burn a vegetable oil includes a preheater for heating the vegetable oil fuel supplied to the furnace for burning. The terms “furnace” and “boiler” are used interchangeably throughout this disclosure. The use of such terms is intended to be inclusive of all such devices whose primary purpose is the generation of heat through the combustion process. Furthermore, the term “vegetable oil fuel” includes all plant based oils, including oils derived from vegetables, fruits, grains, plant stocks and combinations thereof. The vegetable oil fuel may be derived from a single plant source or be derived from multiple plant sources. For example, if waste vegetable oil is used for fuel, such is usually a combination of many types of vegetable oils derived from a variety of plant sources. The term “type of vegetable oil” refers to the derived source of the vegetable oil. For example, palm oil may be referred to as a type of vegetable oil and the same would be true corn oil. Furthermore, waste vegetable oil may be referred to as a type of vegetable oil.

### Preheater

The fuel preheater may be any device capable of heating the vegetable oil fuel to a desired temperature prior to the fuel being introduced to the furnace/boiler. Typically, the preheater comprises an electric heating element operatively affixed to a fuel supply line leading directly to the furnace for introducing the vegetable oil fuel to the furnace.

For example, the preheater may be placed on or into the fuel line in between the fuel pump output and the fuel nozzle assembly. The heater may be a 2,200 W 220V electric water heater element. In one embodiment the preheater can be run at 120V to reduce the heat output of the heater. The elements of the heater may be coated with a ceramic.

The fuel line between the pump and the nozzle assembly is typically substituted for a longer length and having the same diameter line as the line normally found on the furnace. Copper lines are preferably over steel lines since steel lines tend to be brittle and split after a few heating cycles to the appropriate temperature. The fuel lines are typically wrapped around the length of the heating element of the preheater and then connect to the fuel pump and nozzle assembly. The fuel line can be wrapped around the heating element to a sufficient degree as to heat a desired quantity of vegetable oil fuel. By way of example, the line may be wrapped around the element 4 to 6 times. Of course such wrapping is dependent upon the dimensions of both the fuel line and heating element.

Toward the top of the heating element with the fuel line wrapped around it, there is thermocouple from a gas powered power-heater/furnace. It should be preferably placed approximately ¾ way up from the bottom of the heating element, with about one inch of the tip in contact with both the heating element and tubing. It is mounted to the assembly with thin steel wire wrapped around the thermocouple at it's base, and around the heating element and fuel line, or a steel clamp can be used

The whole heating element assembly may be wrapped in an insulating material such as foil preferably just above the electrical connections at the base up to the top, but with a space so the foil does not touch the thermocouple. If the foil touches the thermocouple, it interferes with it reading correctly. The probe of the thermocouple can also be coated with ceramic clay to prevent electrical leakage from interfering with the reading and or damaging the electronic control system.

The thermocouple terminals connect to a voltage measurement input on the computing device through a shielded cable, such as Cat-5, with a low-impedance electrical load across the terminals to attenuate high-voltage electrical noise. The fuel pre-heater assembly heating element is connected through a 120V relay that is triggered by a low-voltage relay, that is driven by two ganged together digital outputs of the computing device.

### Fuel Preparation

When waste vegetable oil fuel is used, it should be separated for water, settle filtered and/or filtered down to at least 10 microns, preferably 5 microns before it is put in the tank. The filtering and/or water separation can also be done between the tank and the furnace if necessary.

### Filter Heater

Installation of a 15 W 120V heating element on the oil-fuel filter located at the tank fuel output. It is necessary because many types of vegetable oil fuel cloud at low temperatures, even temperatures above freezing. The heater is strapped to the bottom of the filter element with a metal clamp. It is connected to a constant-on AC power source.

### Computing Device

The computing device may be any device capable of executing instructions and receiving and transmitting signals. The term “computing device” includes one or more computing devices which may be used alone or in conjunction with each other. Furthermore, the computing device may include a display interface, such as an LCD monitor and an input device such as a keyboard. An example of a computing device for use with the present invention is the SPORT232 data acquisition and control board which may be used in conjunction with a further computing device.

The computing device may be programmed to executes a variety of instructions. For example, the computing device may turn the furnace/boiler on/off in response to the wall thermostat signal and heat the vegetable oil fuel precisely to the set temperature needed for ignition in the furnace/boiler to occur. The computing device further precisely regulates the temperature during operation to prevent fuel scorching and to allow for successful air/fuel ratio tuning. (Changes in temperature result in changes of fuel viscosity, which results in changes in the fuel flow rate.) The device further provides diagnostic feedback to assist in troubleshooting and tuning the system. Furthermore, a bypass mode may be provided to allow for running on conventional fuels, such as regular No. 2 Heating Oil.

The computing device may be further programmed to instruct the continued operation of the furnace in the possible event of a sensor failure or continued operation in a momentary data error occurs in the computing device. The computing device may further instruct the shutting down if an error that cannot be resolved is encountered and provide an indication of software and sensor failure.

Upon starting the computing device, instructions may verify the date/time (for event logging) is valid. The display of the computing device may provide a sets-up screen in the desired display mode, dividing it into sections having different messages, including displaying the title and initial fault messages. The computing device may retrieve the minimum target temperature and then display an online message before entering the main control loop.

The main control loop instructions of the computing device includes polling the logic module (state machine) and retrieving the data presented to the user on the status screen from the logic module. The data presented includes by way of example and not limitation the state of the machine mode, the heat requested, the preheater On/Off, temperature of the preheater in Centigrade, remaining delay time, and is the temperature sensor (thermocouple) online. Furthermore the data presented may include an update of the status display.

The shutdown instructions include indicating a shutdown message and the turning off of all logic outputs, (furnace and preheater). If shutdown caused by a fault count exceeded, the user may be prompted to press an input key such as [R] for restart and [Q] for quit.

The control logic instructions may be implemented using the following example states. The example states are provided by way of example and not limitation. The states include:

| | | |
|---|---|---|
| 1. | ModeOff | All off, waiting for thermostat input to go high. |
| 2. | ModePrimeStart | Turns on the furnace to prime, initialize timer. |
| 3. | ModePrime | Waiting the specified prime duration to complete. |
| 4. | ModePreheatStart | Turns on the preheater. |
| 5. | ModePreheat | Waiting for the preheat temperature to be reached. |
| 6. | ModeDelayStart | Initialize timer. |
| 7. | ModeDelay | Maintain temperature while waiting the specified delay |
| | | duration for the heat to soak into the fuel. |
| 8. | ModeFurnaceStart | Turns on the furnace. |
| 9. | ModeFurnaceRun | Maintain the specified run temperature. |
| 10. | ModeFurnaceStop | All off. |
| 11. | ModeCoolDelayStart | Initialize timer. |
| 12. | ModeCoolDelay | Waiting for specified cool duration to elapse. |
| 13. | ModeCoolPrimeStart | Turns on furnace to pump hot fuel out of the line to prevent |
| | | clogging. |
| 14. | ModeCoolPrime | Runs furnace until temperature has dropped sufficiently. |

In a typical operation, the states are progressed through sequentially, but there are exceptions, such as the thermostat signal becoming low during states 2 through 7. If that occurs, state 10 is immediately transitioned to.

The status of the system is displayed by a control panel which may make use of color and informative messages. The software instructions may provide audio feedback when the heater is on, and when an error occurs. There may be two sounds that indicate the heater is on, one sound for normal mode and the other for sensor-offline mode.

In the ordinary operation no user intervention is required, but for control system maintenance, and for system troubleshooting three commands may be provided; [ESC]=Shutdown, [Enter]=Cancel delay, and [Z]=Toggle bypass mode. The bypass mode is used to allowed operation on fuels which do not require heating, such as regular No. 2 Heating Oil. The software instruction may be programmed using most any computer language. For example the instruction may be programmed in Visual BASIC for DOS Professional 1.0.

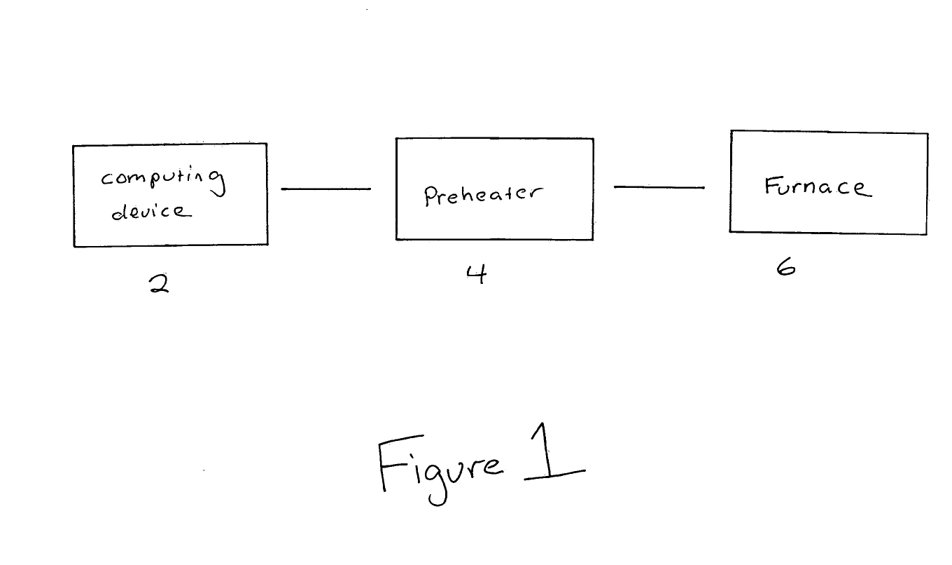

Referring now in greater detail to the drawings in which like numerals indicate like items throughout the several views, FIGS. 1-5 depict the present apparatus and method of for modifying a conventional fossil fuel furnace/boiler to burn a vegetable oil, in the various embodiments of the present invention.

FIG. 1 is a simple block flow diagram illustrating the basic relationship between the major components of the present invention. The computing device 2 sends and receives signals and executes instructions based upon such signals. The computing device 2 may be connected to other components such as a wall thermostat and the furnace 6. The computing device 2 directs the heating of the vegetable oil fuel to the desired minimum target temperature by the preheater 4. The computing device 2 also performs further functions as previously discussed.

The preheater 4 as shown in FIG. 1 is operatively connected to both the computing device 2 and the furnace 6. The preheater 4 heats the vegetable oil fuel to the desired minimum target temperature. The vegetable oil fuel is housed and supplied to the furnace via a fuel supply line. In one embodiment, the preheater heats the vegetable oil fuel as it is housed in the fuel supply line.

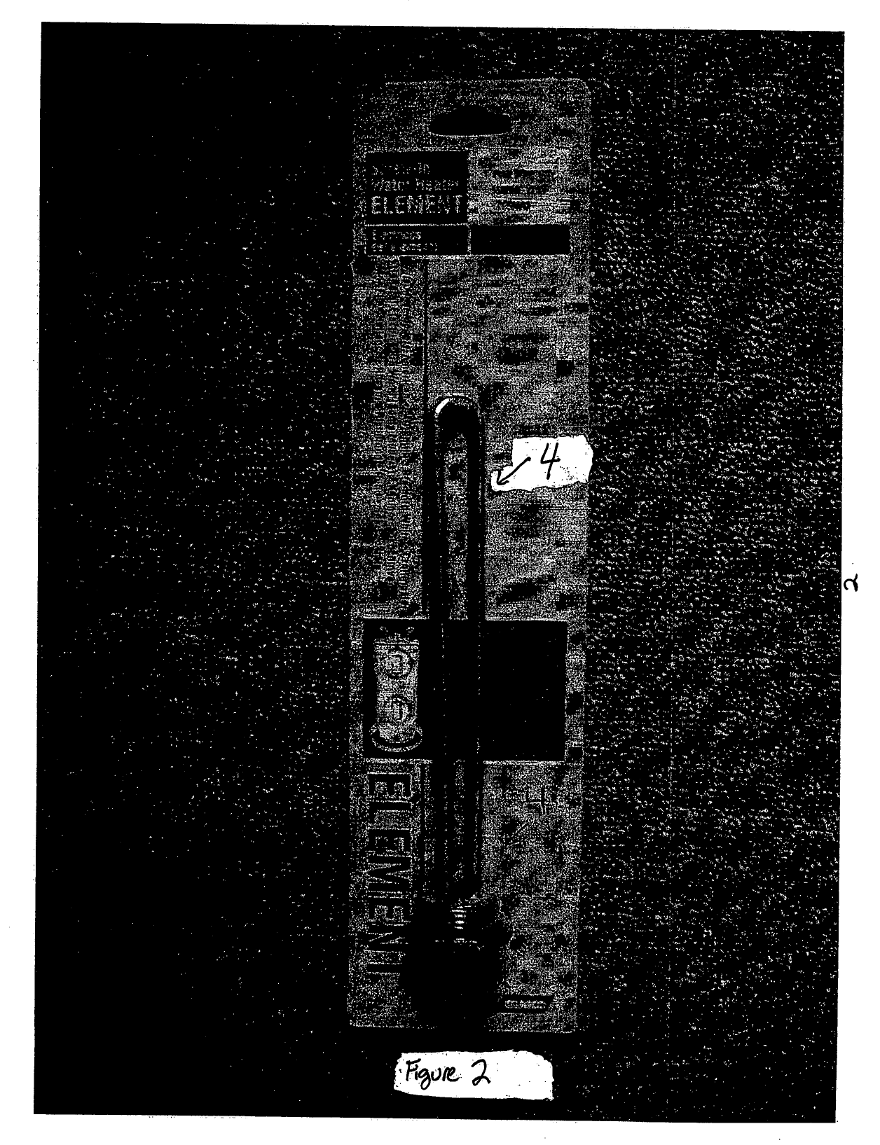

FIG. 2 illustrates one embodiment of the preheater 4. As shown in FIG. 2, the preheater 4 comprises an electronic heating element. Of course, the present invention may utilize most any known heating element or heating apparatus for heating the vegetable oil fuel to the desired minimum target temperature for a type of vegetable oil used as fuel. The element shown in FIG. 2 is commonly available and relatively safe for use in the present invention.

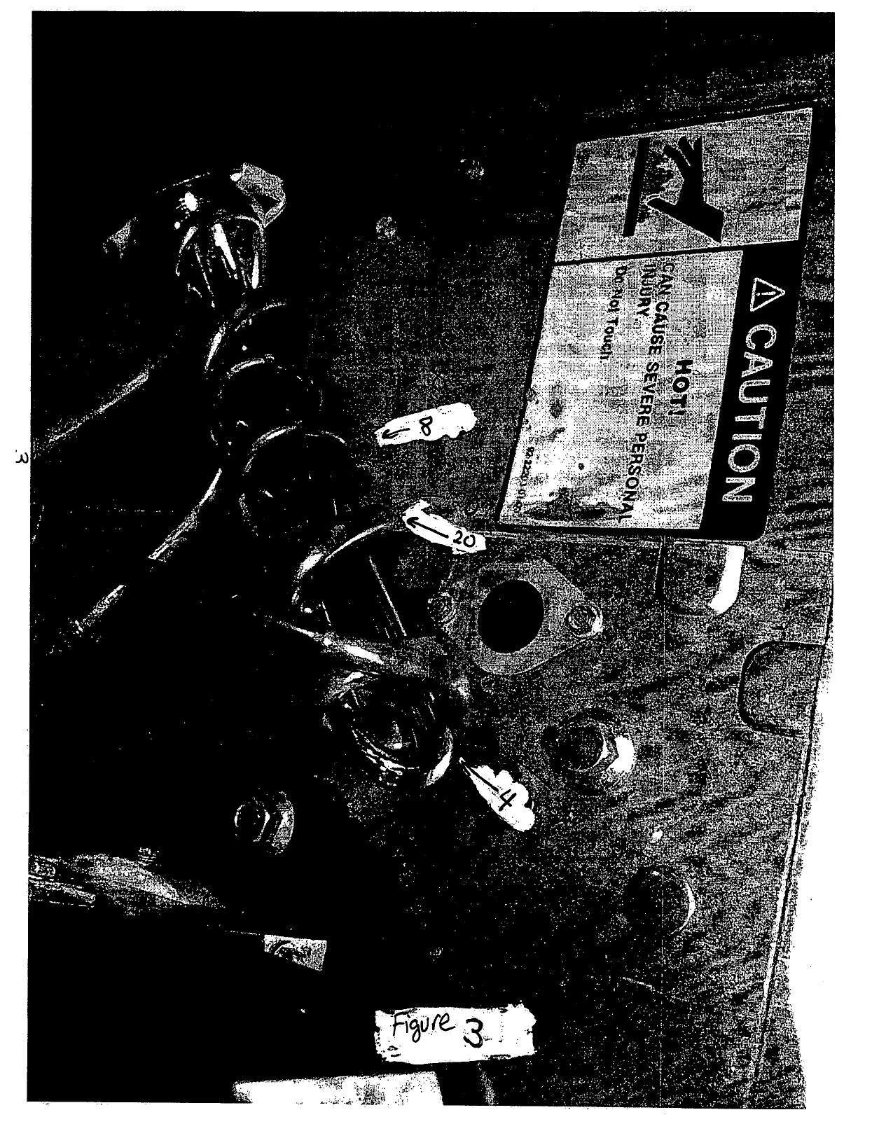

FIG. 3 depicts the preheater 4 in cooperation with the fuel line 20 to form a preheater assembly 8. The terms “preheater” and “preheater assembly” may be used interchangeably within the present disclosure to describe an element that preheats the vegetable oil fuel to the minimum target temperature. While the fuel line 20 is shown in this figure as being wrapped around the preheater 4, it is also contemplate that other configurations may be used to transfer the heat generated by the preheater to the vegetable oil fuel contained in the fuel line 20. For instance, the fuel line 20 may simply follow along and be attached to the exterior or interior curve of the preheater 4.

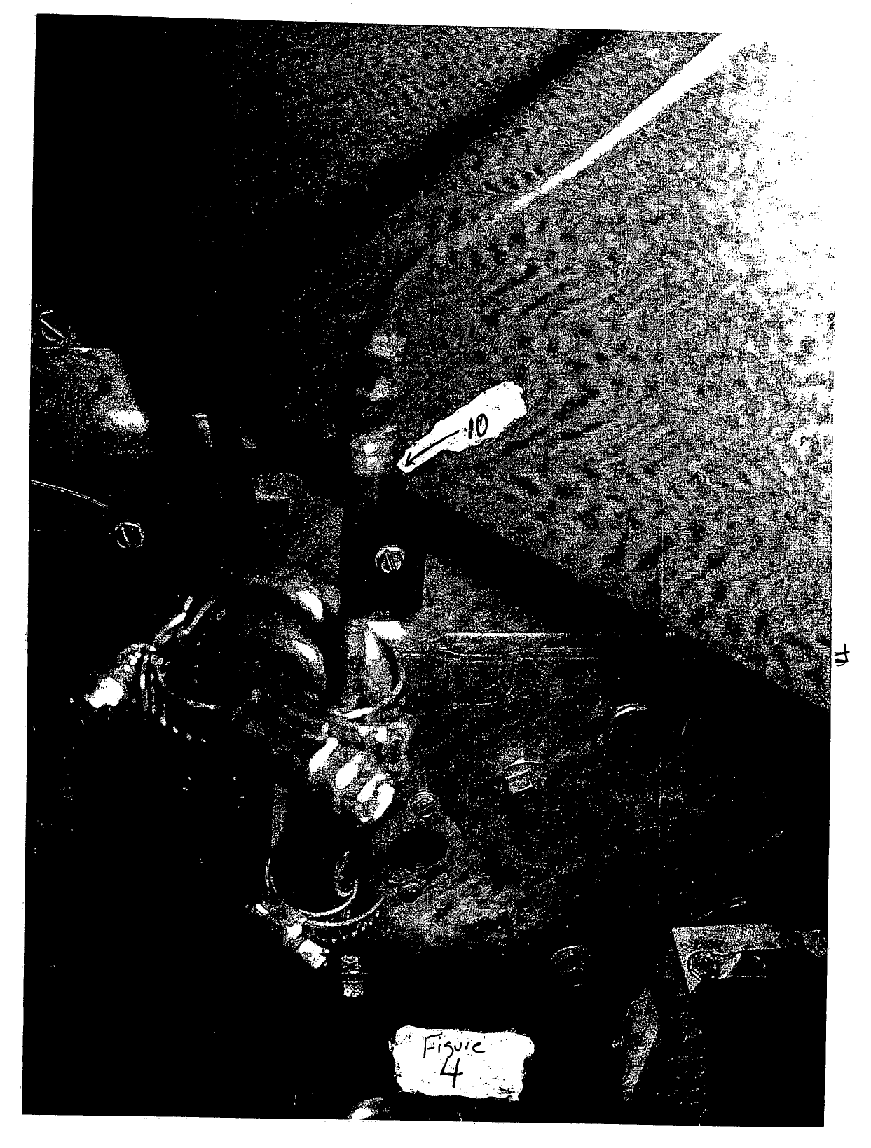

FIG. 4 illustrates the thermocoupler 10 used in cooperation with the preheater 4 for detecting and relaying a temperature to the computing device 2. The computing device 2 thus monitors the temperature of the oil and adjusts the power and/or time duration of such power supplied to the preheater 4. While a thermocoupler 10 is shown in FIG. 4, other temperature sensing devices are also contemplated. For example, the temperature sensing device may be thermistor and/or a resistance temperature detector.

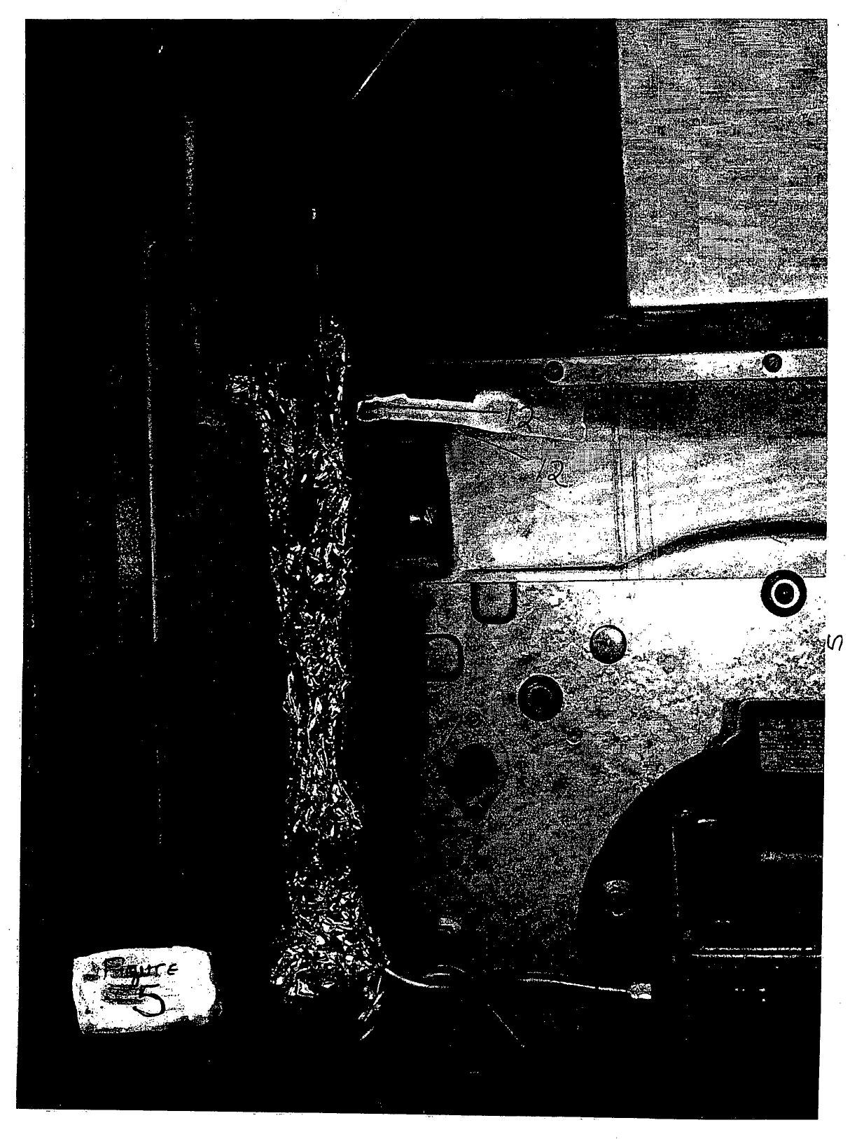

FIG. 5 illustrates the preheater 4 being housed in an insulating barrier 12. The insulating barrier 12 shown in FIG. 5 is comprised of aluminum foil. However other types of insulating barriers 12 are contemplated for the present invention. Preferably, the insulating barrier 12 must be able to withstand elevated temperatures and be nonflammable.

While Applicant has set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. An apparatus for modifying a conventional fossil fuel furnace/boiler to burn a vegetable oil comprising:
a preheater for heating the vegetable oil fuel supplied to the furnace for burning; and
a computing device connected to the preheater for regulating the temperature of the vegetable oil fuel supplied to the furnace.

2. The apparatus of claim 1, wherein the computing device directs the preheater to heat the vegetable oil fuel to at least a minimum target temperature before the delivery of the vegetable oil fuel to the furnace for combustion.

3. The apparatus of claim 2, wherein the minimum target temperature is the difference, plus or minus 2° C., of the fuel flash point of the type of vegetable oil fuel used minus an ignition energy of the furnace/boiler.

4. The apparatus of claim 2, wherein the minimum target temperature is the difference, plus or minus 5° C., of the fuel flash point of the type of vegetable oil fuel used minus an ignition energy of the furnace/boiler.

5. The apparatus of claim 2, wherein the minimum target temperature is the difference, plus or minus 10° C., of the fuel flash point of the type of vegetable oil used minus an ignition energy of the furnace/boiler

6. The apparatus of claim 2, wherein the minimum target temperature is at least 250° C.

7. The apparatus of claim 1, further including the computing device directing the purging the nozzle with fuel before or at the shutdown of the furnace to prevent fuel from singing in a nozzle.

8. The apparatus of claim 1, further including a nozzle for atomizing the fuel in the furnace wherein the nozzle is a variable flow electronically controlled nozzle.

9. The apparatus of claim 1, further including a fuel tank outlet heater comprising a heating element operatively placed in conjunction with an oil-fuel filter for heating the vegetable oil fuel as it exits a storage tank.

10. An apparatus for modifying a conventional fossil fuel furnace/boiler to burn a vegetable oil comprising:
a preheater for heating the vegetable oil fuel supplied to the furnace for burning; and
a computing device connected to the preheater for regulating the temperature of the vegetable oil fuel supplied to the furnace,
wherein the computing device directs the preheater to heat the vegetable oil fuel to at least a minimum target temperature; and
wherein the minimum target temperature is the difference, plus or minus 5° C., of the fuel flash point of the type of vegetable oil fuel used minus an ignition energy of the furnace/boiler.

11. The apparatus of claim 10, wherein the minimum target temperature is the difference, plus or minus 2° C., of the fuel flash point of the type of vegetable fuel in degrees Celsius used minus an ignition energy of the furnace/boiler.

12. The apparatus of claim 10, wherein the preheater includes a temperature sensor detecting the temperature of the vegetable oil fuel supplied to the furnace and operatively connected to the computing device.

13. The apparatus of claim 10, further including a nozzle for atomizing the fuel in the furnace wherein the nozzle is a variable flow electronically controlled nozzle.

14. The apparatus of claim 10, further including the computing device directing the purging the nozzle with fuel before or at the shutdown of the furnace to prevent fuel from singing in a nozzle.

15. The apparatus of claim 10, wherein the preheater includes a heating element operatively connected to the fuel supply line delivering fuel to the furnace.

16. The apparatus of claim 10, wherein the vegetable oil fuel is heated to at least the minimum target temperature before the delivery of the vegetable oil fuel to the furnace for combustion.

17. A method of modifying a conventional fossil fuel furnace/boiler to burn a vegetable oil comprising the steps of:
heating the vegetable oil fuel supplied to the furnace for burning;
detecting the temperature of the vegetable oil fuel supplied to the furnace for burning;
determining a minimum target temperature corresponding to a type of vegetable oil fuel, wherein the minimum target temperature is the difference, plus or minus 5° C., of the fuel flash point of the type of vegetable oil fuel used minus an ignition energy of the furnace/boiler; and
regulating the vegetable oil fuel supplied to the furnace for combustion to a temperature corresponding to the minimum target temperature.

18. The method of claim 17, further including purging the nozzle with fuel before or at the shutdown of the furnace to prevent fuel from singing in a nozzle.

19. The method of claim 17, wherein the vegetable oil fuel is heated to at least the minimum target temperature before the delivery of the vegetable oil fuel to the furnace for combustion.

20. The method of claim 17, further including turning on the furnace prior to delivering the heated vegetable oil fuel.
